(19) United States
(12) Patent Application Publication
(10) Pub. No.: US 2026/0056243 A1
(43) Pub. Date: Feb. 26, 2026

(54) DETERMINING AN OPERATIONAL LIMIT FOR A CIRCUIT COMPONENT WITH SELF-HEATING

(71) Applicant: Microchip Technology Incorporated, Chandler, AZ (US)

(72) Inventors: Mazhar Hoque, Gilbert, AZ (US); Amit Rai, Chandler, AZ (US); Samir Fuke, Tempe, AZ (US); Joseph Rascon, Chandler, AZ (US); Hoi Yun Henry Chan, Lachine (CA); Randy Yach, Phoenix, AZ (US)

(73) Assignee: Microchip Technology Incorporated, Chandler, AZ (US)

(21) Appl. No.: 19/036,836

(22) Filed: Jan. 24, 2025

Related U.S. Application Data
(63) Continuation-in-part of application No. 18/810,767, filed on Aug. 21, 2024.
(60) Provisional application No. 63/727,456, filed on Dec. 3, 2024.

(51) Int. Cl. G01R 31/26; G06F 30/27; G06F 119/04

(52) U.S. Cl. CPC G01R 31/2642; G06F 30/27; G06F 2119/04

(57) ABSTRACT

Systems and methods for determining an operational limit for a circuit component are disclosed. The system may include an operational limit generation system including instructions stored in non-transitory computer-readable medium and executable by a processor to receive input parameters related to a component, perform an age-dependent analysis of the component based on the input parameters, and determine an operational limit for the component based on a result of the age-dependent analysis of the component. The age-dependent analysis may include performing a non-aging simulation of the component and a plurality of aging simulations of the component including a simulation of an aging operation of the component based on aging conditions specified by the input parameters, a different value of at least one operational parameter of the component, and effects of self-heating on aging conditions of the component, and comparing results of the aging simulations with a result of the non-aging simulation.

### PRIORITY

This application is a continuation-in-part of U.S. patent application Ser. No. 18/810,767 filed Aug. 21, 2024 and claims priority to U.S. Provisional Ser. No. 63/727,456 filed Dec. 3, 2024, the contents of which are hereby incorporated in their entirety.

### TECHNICAL FIELD

The present disclosure relates to determining an operational limit for a circuit component.

### BACKGROUND

The performance of electronic circuit components, for example transistors and other semiconductor devices, typically degrades over time due to one or more factors, for example hot carrier injection (HCI), bias temperature instability (BTI), or any combination thereof, without limitation. This age-dependent degradation is particularly significant in certain advanced semiconductor process technology nodes, for example technologies of 55 nm and below. Additionally, self-heating effects may make degradation due to HCI or BTI even worse in some advanced semiconductor process technology nodes, for example technologies of 16 nm and below.

A circuit designer or manufacturer using an Electronic Design Automation (EDA) tool (for example a Cadence, Synopsys, or Ansys EDA platform) to design a circuit, may attempt to determine operational ranges for respective circuit components (e.g., transistors) that allow for long-term operation with acceptable age-related degradation. Such operational range is often referred to as a safe operating area (SOA), the extents of which are referred to as SOA limits. Conventional techniques for determining SOA limits include using a spreadsheet (e.g., Excel) or other online calculator. Such techniques are generally primitive, providing a rough estimate of SOA limits, and often inaccurate. Conventional techniques typically involve checking the performance of each circuit components by a largely manual process, performed outside the relevant design environment, e.g., outside the EDA tool used for the relevant circuit design. This largely manual checking of circuit components may be slow and time consuming.

Conventional tools often require a separate calculation process for each mode of degradation, e.g., BTI and HCI, and cannot analyze BTI and HCI collectively. In addition, conventional tools typically cannot check a recovery factor for BTI. In addition, for transistor design, conventional tools typically provide a generic maximum operational voltage, without differentiating between drain-source voltage (Vds) and gate-source voltage (Vgs), and typically cannot provide a maximum body-source voltage (Vbs). Further, conventional tools cannot account for self-heating effects in circuit performance and SOA limits determined using conventional tools may underestimate degradation due to HCI and BTI.

Conventional EDA tools typically have some capability to run aging simulations, but such simulations can be time-consuming. In addition, such aging simulations are typically performed at the end of the circuit design cycle, thus often requiring an extensive redesign of the circuit in response to the aging simulation results. Still further, EDA tools typically do not have capability to generate maximum allowable voltage limits for a specific application.

### SUMMARY OF THE INVENTION

Aspects provide systems and methods for determining an operational limit for a circuit component.

Examples of the present disclosure may include a non-transitory computer-readable medium. The non-transitory computer-readable medium may include instructions executable by a processor. The instructions may cause the processor to receive a set of input parameters related to a circuit component. The instructions may also cause the processor to perform an age-dependent analysis of the circuit component based on the set of input parameters. The age-dependent analysis may include performing a non-aging simulation of the circuit component by simulating a non-aging operation of the circuit component. The age-dependent analysis may also include performing a plurality of aging simulations of the circuit component. An aging simulation of the plurality of aging simulations may include a simulation of an aging operation of the circuit component based on (a) an aging condition specified by the set of input parameters, (b) a different value of at least one operational parameter of the circuit component, and (c) effects of self-heating on aging conditions of the circuit component. The age-dependent analysis may include comparing respective results of the plurality of aging simulations with a result of the non-aging simulation. The instructions may cause the processor to determine an operational limit for the circuit component based at least on a result of the age-dependent analysis of the circuit component.

In combination with any of the above examples, the instructions may be further executable by the processor to apply the operational limit to a circuit design to detect design violations.

In combination with any of the above examples, the operational limit may include a safe operating area (SOA) limit for the circuit component.

In combination with any of the above examples, the non-aging simulation and the plurality of aging simulations of the circuit component may be performed by a SPICE simulator.

In combination with any of the above examples, the aging simulation in the plurality of aging simulations of the circuit component may include a simulation of the aging operation of the circuit component based on (a) the aging condition specified by the input parameters, (b) a different parameter value combination for at least two operational parameters of the circuit component, and (c) effects of self-heating on the aging condition of the circuit component.

In combination with any of the above examples, performing the plurality of aging simulations of the circuit component may include performing multiple aging simulations of the circuit component for each of multiple different values of a first operational parameter of the circuit component. The multiple aging simulations for a respective value of the first operational parameter may include respective aging simulations based on (a) the aging condition specified by the input parameters, (b) the respective value of the first operational parameter, (c) multiple different values of a second operational parameter of the circuit component, and (d) effects of self-heating on aging conditions of the circuit component. The age-dependent analysis may include determining, for each of at least two of the multiple different values of the first operational parameter, a respective limit value derived from results of the multiple aging simulations performed for the respective value of the first operational parameter. The age-dependent analysis may also include determining the operational limit for the circuit component based at least on a result of the age-dependent analysis of the circuit component includes selecting a highest or lowest value of the at least two limit values as the operational limit for the circuit component.

In combination with any of the above examples, the circuit component may be a transistor. The at least one operational parameter of the circuit component may include at least one of a gate-source voltage (Vgs), a drain-source voltage (Vds), or a body-source voltage (Vbs).

In combination with any of the above examples, the non-aging simulation of the circuit component may include simulating an effect of the non-aging operation of the circuit component on a performance metric specified in the set of input parameters. The aging simulation of the circuit component may include simulating an effect of the aging operation of the circuit component on the performance metric.

In combination with any of the above examples, the circuit component may be a transistor. The at least one operational parameter of the circuit component may include at least one of a gate-source voltage (Vgs), a drain-source voltage (Vds), or a body-source voltage (Vbs). The performance metric may be a saturation drain current (Idsat), a linear drain current (Idlin), or a linear threshold voltage (Vtlin).

In combination with any of the above examples, performing the non-aging simulation of the circuit component may include simulating a non-aging operation of a non-aged model of the circuit component derived from the set of input parameters. Performing a respective aging simulation of the circuit component in the plurality of aging simulations may include simulating an aging operation of the non-aged model of the circuit component, generating an aged model of the circuit component based on results of the aging operation of the non-aged model of the circuit component, and simulating an operation of the aged model of the circuit component.

Alone or in combination with any of the above examples, examples of the present disclosure may include a non-transitory computer-readable medium comprising instructions executable by a processor. The instructions may cause the processor to receive a set of input parameters related to a transistor. The instructions may also cause the processor to perform an age-dependent analysis of the transistor. The age-dependent analysis may include performing a non-aging simulation of the transistor by simulating a non-aging operation of the transistor to determine a non-aged value of a performance metric. The age-dependent analysis may also include performing a plurality of aging simulations of the transistor, wherein performing an aging simulation in the plurality of aging simulations includes simulating an aging operation of the transistor, using (a) aging conditions specified by the input parameters, (b) a different value of at least one operational parameter of the transistor, and (c) effects of self-heating on aging conditions of the transistor, to determine a respective aged value of the performance metric corresponding with the respective value of a first operational parameter. The age-dependent analysis may include for each respective aging simulation, comparing (a) the respective aged value of the performance metric corresponding with the respective value of the first operational parameter with (b) the non-aged value of the performance metric to determine a respective aging-based change in the performance metric corresponding with the respective value of the first operational parameter. The age-dependent analysis may additionally include determining, based on the respective aging-based changes in the performance metric corresponding with the respective values of the first operational parameter, a limit value of the first operational parameter corresponding with a threshold value of the performance metric. The instructions may also cause the processor to determine an operational limit for the transistor based at least on the determined limit value of the first operational parameter.

In combination with any of the above examples, the instructions may be further executable by the processor to apply the operational limit to a circuit design to detect design violations.

In combination with any of the above examples, the operational limit may be a safe operating area (SOA) limit for the transistor.

In combination with any of the above examples, performing the plurality of aging simulations of the transistor may include performing multiple aging simulations of the transistor for each of the multiple different values of the first operational parameter of the transistor, wherein the multiple aging simulations for the respective value of the first operational parameter includes respective aging simulations based on (a) an aging condition specified by the input parameters, (b) the respective value of the first operational parameter, (c) multiple different values of a second operational parameter of the transistor, and (d) effects of self-heating on aging conditions of the transistor. The age-dependent analysis may include determining, for each of at least two of the multiple different values of the first operational parameter, a respective limit value derived from results of the multiple aging simulations performed for the respective value of the first operational parameter. The age-dependent analysis may also include determining the operational limit for the transistor based at least on a result of the age-dependent analysis of the transistor includes selecting a highest or lowest value of the at least two limit values as the operational limit for the transistor.

In combination with any of the above examples, the first operational parameter may be a gate-source voltage (Vgs), a drain-source voltage (Vds), or a body-source voltage (Vbs).

In combination with any of the above examples, the non-aging simulation of the transistor may include simulating an effect of the non-aging operation of the transistor on the performance metric specified in the set of input parameters. The aging simulation of the transistor may include simulating an effect of the aging operation of the transistor on the performance metric.

In combination with any of the above examples, the first operational parameter of the transistor may be a gate-source voltage (Vgs), a drain-source voltage (Vds), or a body-source voltage (Vbs). The performance metric may be a saturation drain current (Idsat), a linear drain current (Idlin), or a linear threshold voltage (Vtlin).

Alone or in combination with any of the above examples, examples of the present disclosure may include a method. The method may include receiving a set of input parameters related to a circuit component. The method may also include performing an age-dependent analysis of the circuit component based on the set of input parameters. The age-dependent analysis may include performing a non-aging simulation of the circuit component by simulating a non-aging operation of the circuit component. The age-dependent analysis may also include performing a plurality of aging simulations of the circuit component. An aging simulation of the plurality of aging simulations including a simulation of an aging operation of the circuit component based on (a) aging conditions specified by the input parameters, (b) a different value of at least one operational parameter of the circuit component, and (c) effects of self-heating on aging conditions of the circuit component. The age-dependent analysis may further include comparing respective results of the plurality of aging simulations with a result of the non-aging simulation. The method may additionally include determining an operational limit for the circuit component based at least on a result of the age-dependent analysis of the circuit component.

In combination with any of the above examples, performing the plurality of aging simulations of the circuit component may include performing multiple aging simulations of the circuit component for each of multiple different values of a first operational parameter of the circuit component. The multiple aging simulations for a respective value of the first operational parameter may include respective aging simulations based on (a) the aging conditions specified by the input parameters, (b) the respective value of the first operational parameter, (c) multiple different values of a second operational parameter of the circuit component, and (d) effects of self-heating on aging condition of the circuit component. The age-dependent analysis may include determining, for each of at least two of the multiple different values of the first operational parameter, a respective limit value derived from results of the multiple aging simulations performed for the respective value of the first operational parameter. The age-dependent analysis may also include determining the operational limit for the circuit component based at least on a result of the age-dependent analysis of the circuit component includes selecting a highest or lowest value of the at least two limit values as the operational limit for the circuit component.

Alone or in combination with any of the above examples, examples of the present disclosure may include a system. The system may include an electronic design automation (EDA) tool for development of circuit design including a circuit component. The system may also include an operational limit generation system integrated in the EDA tool. The operational limit generation system may include instructions stored in non-transitory computer-readable medium and executable by a processor. The instructions may cause the processor to receive a set of input parameters related to a circuit component. The instructions may also cause the processor to perform an age-dependent analysis of the circuit component based on the set of input parameters. The age-dependent analysis may include performing a non-aging simulation of the circuit component by simulating a non-aging operation of the circuit component. The age-dependent analysis may also include performing a plurality of aging simulations of the circuit component. An aging simulation of the plurality of aging simulations including a simulation of an aging operation of the circuit component based on (a) aging conditions specified by the input parameters, (b) a different value of at least one operational parameter of the circuit component, and (c) effects of self-heating on aging conditions of the circuit component. The age-dependent analysis may include comparing respective results of the plurality of aging simulations with a result of the non-aging simulation. The instructions may cause the processor to determine an operational limit for the circuit component based at least on a result of the age-dependent analysis of the circuit component.

### BRIEF DESCRIPTION OF THE DRAWINGS

The figures illustrate examples of systems and methods for determining an operational limit for a circuit component.

FIG. 1 illustrates an example system for generating and analyzing circuit designs using operational limits (e.g., SOA limits) for respective circuit components, according to examples of the present disclosure;

FIG. 2 illustrates an example operational limit generation system for generating operational limit (e.g., an SOA limit) for circuit component (e.g., a transistor), according to examples of the present disclosure;

FIG. 3 illustrates a flowchart of an example method for determining an operational limit (Vmax) for an example circuit component, according to examples of the present disclosure;

FIG. 4A-4G illustrate example graphs illustrating various aspects of the example process described in FIG. 3, according to examples of the present disclosure;

FIG. 5 illustrates a flowchart of an example method for generating an operational limit (e.g., maximum operating voltage) for a circuit component (e.g., transistor); and

FIG. 6 illustrates a flowchart of another example method for generating an operational limit (e.g., maximum operating voltage) for a circuit component (e.g., transistor).

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

According to an aspect of the invention, systems and methods for determining an operational limit for a circuit component are provided. The systems and methods may allow for calculation of safe operating area (SOA) limits for hot carrier injection (HCI), bias temperature instability (BTI), or any combination thereof, without limitation, and account for the effects of self-heating. Self-heating may be caused by lack of heat dissipation in the circuit component. For example, the channel structure inside a fin field-effect transistor (FINFET) p-channel metal-oxide-semiconductor (pMOS) may result in difficulties in dissipating heat generated during operation. The calculations may be integrated into an electronic design automation (EDA) tool and used within the design environment. As such, the Vmax limits may be generated and checked for compliance during the design process, potentially reducing the design cycle time because SOA limit checks may be performed at low-level schematic design during the design cycle. Thus, last minute fixes may be eliminated because aging simulations are not delayed and performed at the top level design cycle. The systems and methods may reduce the time and resources used to generate SOA limits and implementing SOA limit checks.

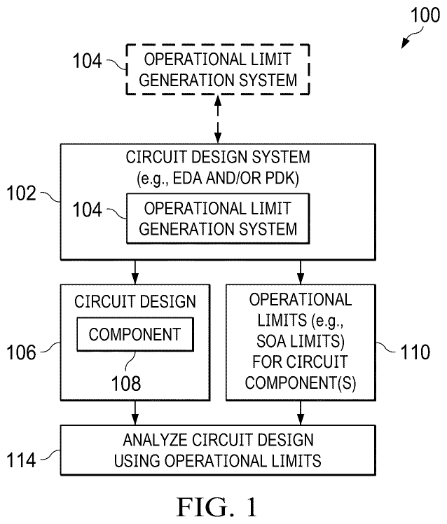

FIG. 1 illustrates an example system for generating and analyzing circuit designs using operational limits (e.g., SOA limits) for respective circuit components, according to examples of the present disclosure. Example system 100 may include circuit design system 102 and operational limit generation system 104. Circuit design system 102 may include any automated or semi-automated system or systems for generating and analyzing a circuit design 106 including various circuit components 108 (e.g., transistors), for example, an electronic design automation (EDA) tool (for example a Cadence, Synopsys, or Ansys EDA platform) to build and analyze circuit designs and/or a physical design kit (PDK) specific to a particular application or technology.

Operational limit generation system 104 may include circuitry to generate operational limits 110 (e.g., SOA limits) for respective circuit components 108 in circuit design 106. Operational limit generation system 104 may generate operational limits 110 for respective circuit components 108 based on respective input parameters (e.g., voltage specifications, operating temperature, minimum lifetime, maximum failure rate). Circuit design system 102 may utilize operational limits 110 generated by operational limit generation system 104 to check circuit design 106 for compliance or design violations (e.g., at various stages during the construction of circuit design 106), as indicated at 114.

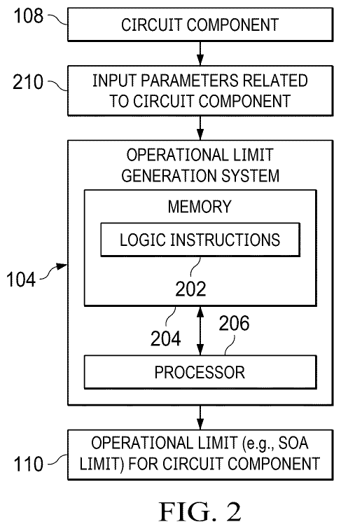

As discussed below with respect to FIG. 2, operational limit generation system 104 may comprise software or other computer-executable instructions stored in non-transitory computer-readable memory and executable by one or more processors. In some examples, operational limit generation system 104 may be integrated in circuit design system 102 (e.g., integrated in an EDA tool). In other examples, operational limit generation system 104 may be separate from circuit design system 102.

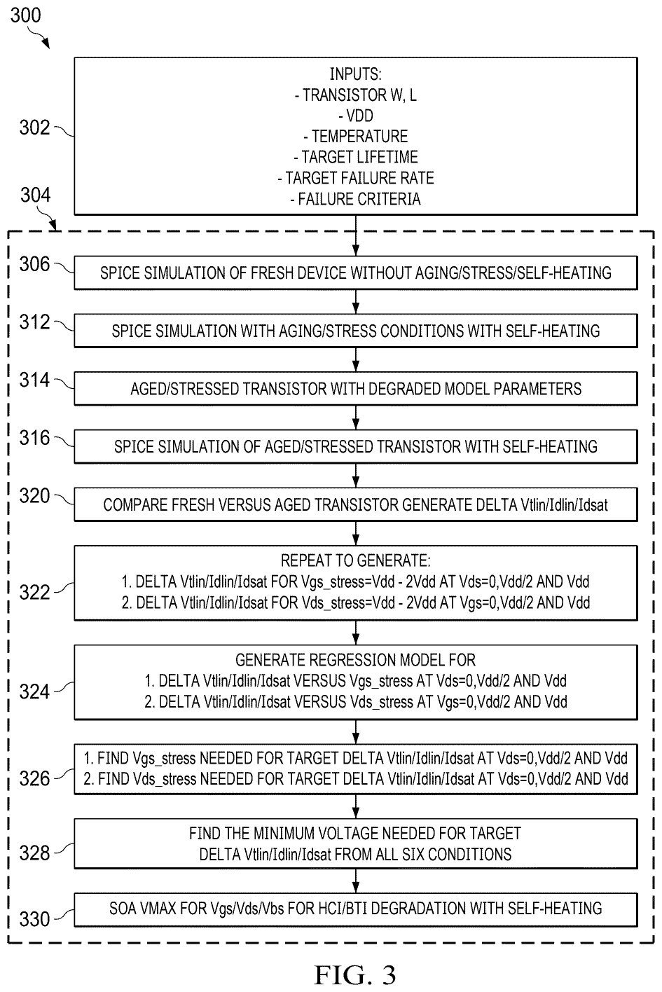

FIG. 2 illustrates an example operational limit generation system for generating operational limit (e.g., an SOA limit) for circuit component (e.g., a transistor), according to examples of the present disclosure. Operational limit 110 may be used by circuit design system 102 to check circuit design 106, as discussed above, according to examples of the present disclosure. As shown, operational limit generation system 104 may include computer-readable logic instructions 202 (e.g., embodied in software and/or firmware) stored in memory 204 and executable by a processor 206 to perform a respective process to generate operational limit 110, for example any of the example processes shown in FIG. 3 and discussed below.

Memory 204 may include one or more type of memory device to store logic instructions 202, for example, read-only memory (ROM), random access memory (RAM, SRAM, DRAM), electrically erasable programmable read-only memory (EEPROM), a PCMCIA card, flash memory, magnetic storage, opto-magnetic storage, hardware registers, and/or any suitable selection or array of volatile or non-volatile memory. Processor 206 may comprise any system, device, or apparatus operable to interpret or execute logic instructions 202, and may include, without limitation a microprocessor, microcontroller, digital signal processor (DSP), application specific integrated circuit (ASIC), or any other digital or analog circuitry to interpret or execute program instructions and/or process data.

As shown in FIG. 2, operational limit generation system 104 may receive input parameters 210 related to circuit component 108 (e.g., a transistor), and generate an operational limit 110 (e.g., a maximum gate voltage) for circuit component 108. FIG. 3 discussed below illustrates example processes implemented by operational limit generation system 104 (e.g., by execution of logic instructions 202 by processor 206) to generate an example operational limit 110 based on example input parameters 210.

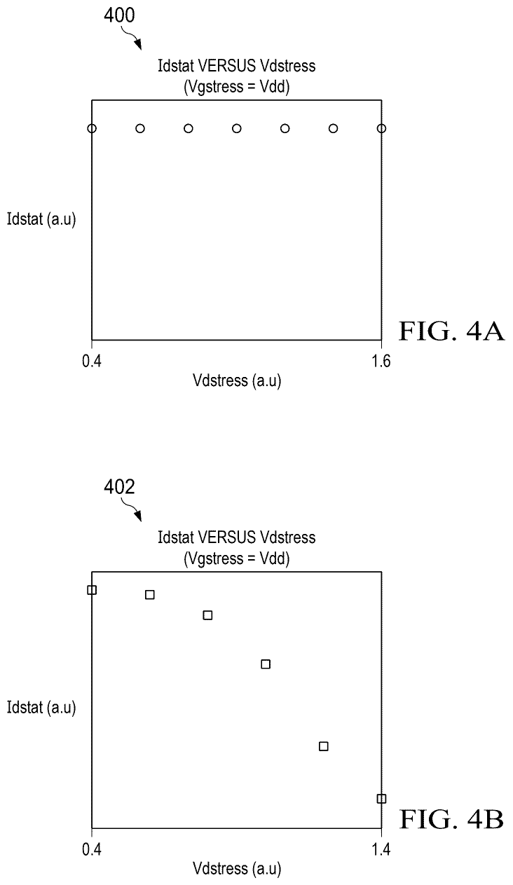

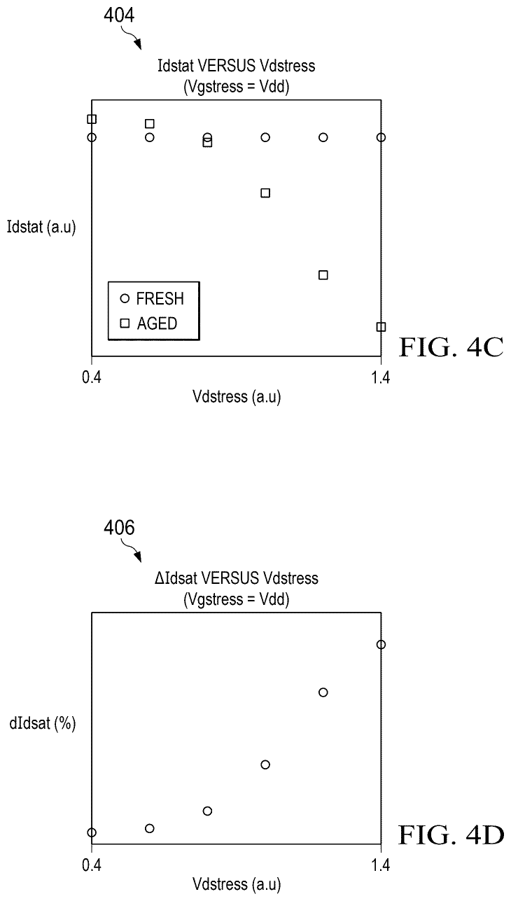

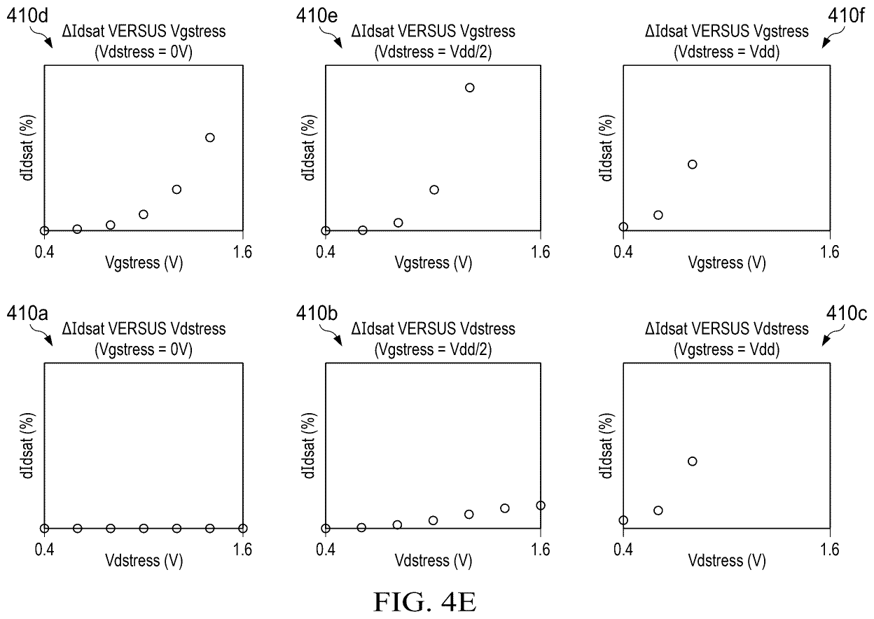

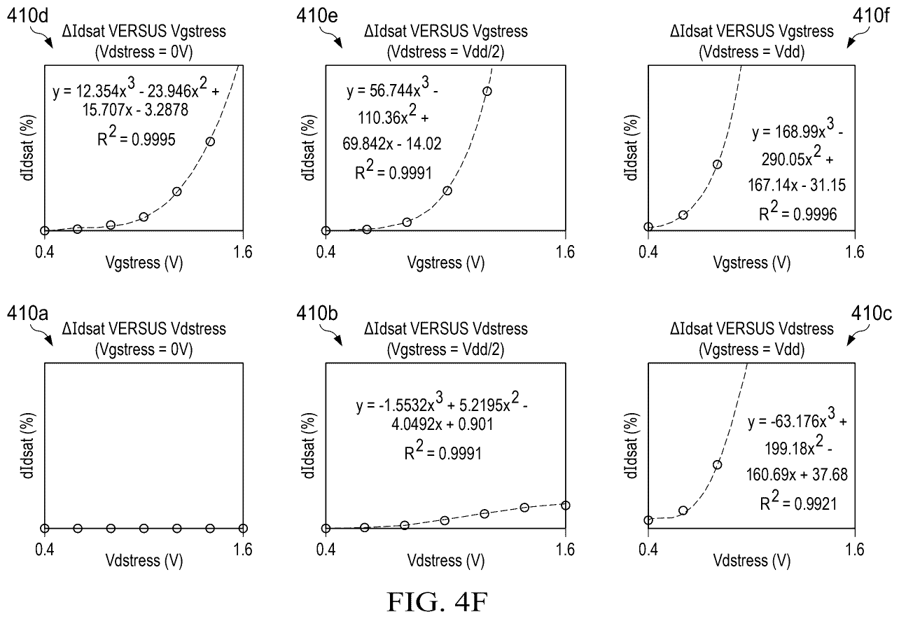

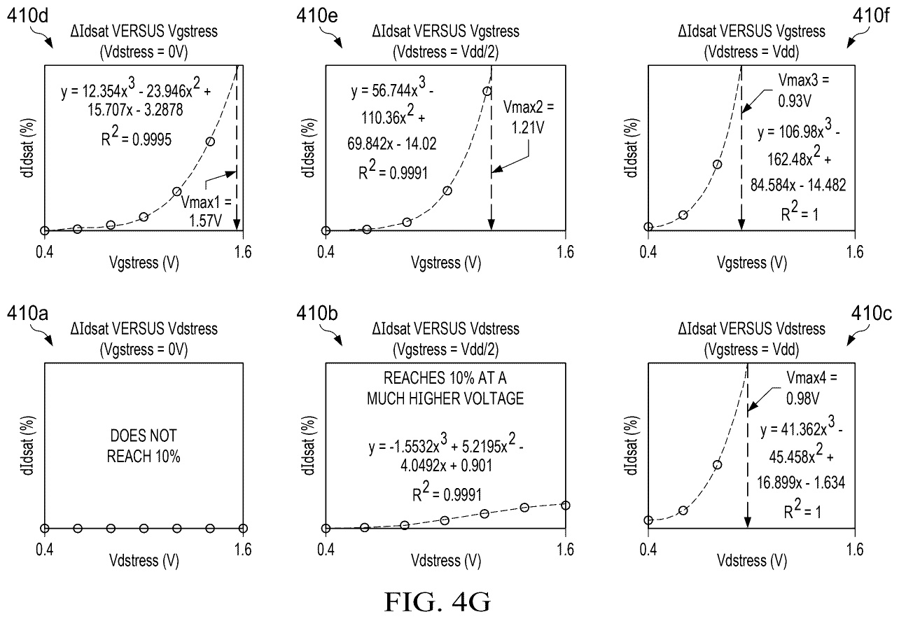

FIG. 3 illustrates a flowchart of an example method 300 for determining an operational limit (Vmax) for an example circuit component, according to examples of the present disclosure. Method 300 may be at least partially implemented by operational limit generation system 104 shown in FIG. 2, for example by execution of respective logic instructions 202 (e.g., software) by processor 206, or any other system operable to implement method 300. FIG. 4A-4G illustrate example graphs illustrating various aspects of the example process described in FIG. 3, according to examples of the present disclosure. FIG. 4A-4G discussed below show details of one example implementation of the example method 300, to facilitate an understanding of method 300. The discussion of method 300 below is directed to the example transistor simulation disclosed in FIG. 4A-4G; however, the transistor is one example, such that method 300 may be similarly applied to other circuit components. Although examples have been described above, other variations and examples may be made from this disclosure without departing from the spirit and scope of these disclosed examples.

In some examples, method 300 results in a value of Vmax that is adopted as the operational limit (Vmax) for the circuit component. In other examples, method 300 outputs a value of Vmax that is compared with at least one other value of Vmax output by other process(es) to determine the operational limit (Vmax) for the circuit component.

At block 302, the operational limit generation system may receive a set of input parameters related to the example circuit component (e.g., a transistor). For example, the set of input parameters may specify:
(a) dimensions of the circuit component (e.g., width=10 microns, length=100 nm),
(b) maximum operating voltage Vdd (e.g., 0.9V),
(c) maximum operating temperature of the circuit component (e.g., 125° C., maximum junction temperature of transistor),
(d) target lifetime (e.g., 10 years),
(e) target failure rate (e.g., 1000 ppm), and
(f) failure criteria (e.g., 10% change (degradation) in saturation current (ΔIdsat)).

In other examples, the failure criteria may specify a maximum change in linear drain current (Idlin) (e.g., ΔIdlin=10%) or linear threshold voltage (Vtlin) (e.g., ΔVtlin=10%), or alternatively the input parameters may specify multiple alternative failure criteria, for example, ΔIdsat=10% ΔIdlin=10%, or ΔVtlin=10%.

At block 304, the operational limit generation system may perform an operational limit generation process to generate an operational limit for the circuit component with respect to respective failure modes, in particular failures from hot carrier injection (HCI) degradation or bias temperature instability (BTI) including the effects of self-heating. In some examples, the operational limits may be generated to account for separate and combined HCI and BTI including the effects of self-heating. Block 304 may include block 306 through block 330.

At block 306, the operational limit generation system may perform a non-aging simulation of the circuit component by simulating a non-aging operation of the circuit component, for example, based on one or more of the input parameters, for example using a SPICE circuit simulator program. Simulating a non-aging operation of the circuit component may include (a) generating non-aged model of the circuit component based on respective input parameters received at block 302 (e.g., dimensions, materials, operating specifications of the circuit component), and (b) operating the non-aged model according to respective input parameters received at block 302 (e.g., Vdd, use temperature), and without considering time-based degradation (i.e., aging) or effects of self-heating of the circuit component, to determine a resulting value of a target performance metric specified by the input parameters (e.g., in this example, Idsat).

FIG. 4A illustrates a graph 400 showing an example result (Idsat versus Vds) of the non-aging simulation, wherein Idsat is measured using Vds=Vgs=Vdd (0.9V in this example). Although the simulation is performed for Vds=0.9V, the resulting Idsat value is applied to each other value of Vds, to provide a baseline for comparison with Idsat values resulting from aging simulations, as discussed below.

At block 312, the operational limit generation system may perform aging simulations of the circuit component. The aging simulations may be performed using selected parameter values and may account for the effects of self-heating. For example, the operational limit generation system may select values of an operational parameter (e.g., Vds and Vgs) to analyze, for example by selecting Vds to analyze through a range of Vds values from Vdd to 2*Vdd, and using a selected Vgs value (Vgs=Vdd). First, the operational limit generation system may simulate (e.g., using a SPICE simulator) an operation of the non-aged model generated at block 306 for a first value of the operational parameter, Vds in the specified range of Vdd to 2*Vdd, and using Vgs=0. For example, the operational limit generation system may perform a first simulation using Vds=Vdd and Vgs=0, applied for the target lifetime of 10 years.

The simulation at block 312 may alter certain characteristics of the circuit component, e.g., gate oxide charge, electron/hole mobility. At block 314, the simulator program (e.g., a SPICE simulator) may generate an aged model of the circuit component based on such altered characteristics of the circuit component.

At block 316, the operational limit generation system may then operate the aged model using Vds=Vgs=Vdd (0.9V in this example) to determine a respective Idsat value. The respective Idsat value may account for the effects of self-heating.

The operational limit generation system may repeat the process of blocks 312-316 for each other value of Vds, for example Vds=1.2*Vdd, Vds=1.4*Vdd, Vds=1.6*Vdd, Vds=1.8*Vdd, and Vds=2*Vdd, to determine a respective Idsat value for each value of Vds, accounting for the effects of self-heating.

FIG. 4B illustrates a graph 402 showing example results (Idsat versus Vds) of the respective aging simulations for the various values of Vds (e.g., Vds=1.2*Vdd, 1.4*Vdd, 1.6*Vdd, 1.8*Vdd, and 2*Vdd), with Vgs=Vdd.

At block 320, the operational limit generation system may compare the results (e.g., the Idsat values shown in FIG. 4B) of the aging simulations from block 316 with the results (e.g., the Idsat value) of the non-aging simulation from block 306. FIG. 4C illustrates a graph 404 showing the results of the non-aging simulation and aging simulations for Vds=0.4 to 1.4V with Vgs=Vdd. FIG. 4D illustrates a graph 406 showing ΔIdsat (change in Idsat between the aging and non-aging simulations) versus Vds.

At block 322, the operational limit generation system may repeat the process at blocks 312-320 to analyze the operational parameters (e.g., Vds) values using other values of Vgs (e.g., Vgs=0 and Vgs=Vdd/2), and the process for analyzing Vds discussed above (i.e., at blocks 312-322) may be repeated to analyze Vgs (i.e., by analyzing Vgs through a range of values from Vdd to 2*Vdd, and using selected Vds value (0, Vdd/2, and Vdd), to generate respective ΔIdsat results for each combination of parameter values.

FIG. 4E illustrates (a) three graphs 410a-410c showing example results (ΔIdsat versus Vds) of the Vds analysis discussed above, wherein graph 410c corresponds with graph 406 shown in FIG. 4D, and (b) three graphs 410d-410f showing example results (ΔIdsat versus Vgs) of the corresponding Vgs analysis.

At block 324, the operational limit generation system may generate a regression model for each respective graph 410a-410f, as shown in FIG. 4F.

At block 326, the operational limit generation system may determine a respective limit value (Vmax) for each graph 410a-410f using each regression models shown in FIG. 4F. For example, as shown in FIG. 4G, for graphs 410d-410f, a respective Vmax limit value may be determined as the value of Vgs (if any) for which the regression line exceeds the target ΔIdsat (e.g., 10%) (specified in the input parameters received at block 302). In this example, a limit value of Vmax=0.93 V is determined from graph 410f. The target ΔIdsat in graph 410d has a limit value of Vmax=1.57V and the target ΔIdsat in graph 410e has a limit value of Vmax=1.21V. The lowest Vmax is selected, resulting in a limit value of Vmax=0.93V as shown in graph 410f.

Similarly, for graphs 410a-410c, a respective Vmax limit value may be determined as the value of Vds (if any) for which the regression line exceeds the target ΔIdsat (e.g., 10%). In this example, as shown in FIG. 4G, limit value of Vmax=0.98V is determined from graph 410c. Of note, the target ΔIdsat is not exceeded in graphs 410a and 410b at the voltages plotted.

At block 328, the operational limit generation system may determine a minimum limit value from the various Vmax limit values determined at block 326, in this example Vmax=0.93V shown in graph 410c. In this example, this minimum limit value (Vmax=0.93V) may be specified as the operational voltage limit for the transistor with respect to potential hot carrier injection (HCI) degradation, bias temperature instability (BTI), or a combination thereof, accounting for the effects of self-heating, according to the input parameters received at block 302. In an example in which multiple failure criteria are specified by the input parameters, for example, ΔIdsat=10% ΔIdlin=10%, or ΔVtlin=10%, the process described above may be repeated for each respective failure criteria (e.g., ΔIdsat, ΔIdlin, and ΔVtlin) to determine respective limit values, which may be compared to determine an operational voltage limit (e.g., the lowest limit value). The maximum voltage limits may then be used to check a circuit design within a design environment to ensure that the design complies with the maximum allowable voltage limit such that the circuit may perform within the design specifications over the circuits intended lifespan.

Method 300 may be used to generate separate voltage limits for different terminals of the circuit component (e.g., drain, gate, body, source). Method 300 may also account for BTI recovery based on duty cycle and frequency. SOA limits may be generated based on specific use cases of geometry, temperature, lifetime, failure rate, failure criteria, or any combination thereof, in terms of delta Vtlin, Idsat, Idlin or any combination thereof.

Although FIG. 3 discloses a particular number of operations related to method 300, method 300 may be executed with greater or fewer operations than those depicted in FIG. 3. In addition, although FIG. 3 discloses a certain order of operations to be taken with respect to method 300, the operations comprising method 300 may be completed in any suitable order.

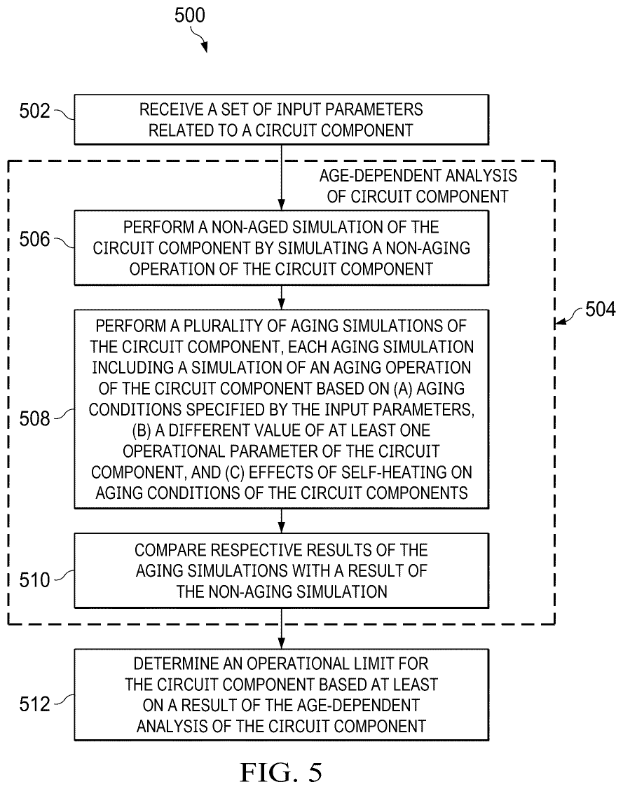

FIG. 5 illustrates a flowchart of an example method 500 for generating an operational limit (e.g., maximum operating voltage) for a circuit component (e.g., transistor). The example method 500 may be implemented by an operational limit generation system, such as operational limit generation system 104 shown in FIG. 2, for example by execution of respective logic instructions 202 (e.g., software) by processor 206.

At block 502, the operational limit generation system may receive a set of input parameters related to a particular circuit component, e.g., a particular transistor to be included in a circuit design for a particular application. The input parameters may include, for example, characteristics of the circuit component itself (e.g., size, operating specifications), parameters related to an expected operation of the circuit component (e.g., temperature), and/or “aging conditions” related to the circuit component (e.g., a target lifetime, a failure rate, and/or particular failure mode(s) to be analyzed).

At block 504, the operational limit generation system may perform an age-dependent analysis of the circuit component based on the set of input parameters. The age-dependent analysis may include blocks 506-510, which may be performed in any order and may be performed at least partially simultaneously.

At block 506, the operational limit generation system may perform a non-aging simulation of the circuit component by simulating a non-aging operation of the circuit component, for example, based on one or more of the input parameters, for example using a SPICE circuit simulator program. Simulating a non-aging operation of the circuit component may include (a) generating a model of a freshly manufactured instance of the circuit component, referred to as a “non-aged model” of the circuit component, based on respective input parameters (e.g., dimensions, materials, operating specifications of the circuit component), and (b) operating the non-aged model according to respective input parameters (e.g., Vdd, use temperature), and without considering time-based degradation (i.e., aging) of the circuit component, to determine a resulting value of a target performance metric (e.g., a saturation current Idsat) specified by the input parameters.

At block 508, the operational limit generation system may perform a plurality of aging simulations of the circuit component. Each aging simulation may comprise an extended simulation of an aging operation of the circuit component based on (a) aging conditions specified by the input parameters, (b) selected value(s) of at least one operational parameter of the circuit component, and (c) the effects of self-heating of the circuit component, to determine a respective value of the target performance metric (e.g., a saturation current Idsat) resulting from such simulated operation. In one example, the operational limit generation system may use a SPICE circuit simulator program or other suitable program(s) to (a) apply selected operational parameter value(s) (e.g., Vds, Vgs, temperature) to the circuit component for the target lifetime specified by the input parameters, which may alter certain characteristics of the circuit component (e.g., gate oxide charge, electron/hole mobility), (b) generate an “aged model” of the circuit component based on such altered characteristics of the circuit component, and (c) operate the aged model to determine a value of the target performance metric (e.g., Idsat).

Different operational parameter value(s) (e.g., Vds, Vgs, temperature) may be used for each aging simulation of the circuit component, to thereby evaluate the effect of varying the operational parameter(s) on the target performance metric. For example, for a circuit component comprising a transistor, each aging simulation may use a different combination of Vgs and Vds values, to evaluate the effect of varying Vgs and/or Vds on the target performance metric, e.g., as discussed below with respect to FIG. 3.

At block 510, the operational limit generation system may compare respective results of each aging simulation from block 508 with the results of the non-aging simulation from block 506, wherein the non-aging simulation from block 506 represents a baseline or reference. For example, as discussed below, the operational limit generation system may determine a change in performance (e.g., Idsat value) between each aging simulation and the reference non-aging simulation.

At block 512, the operational limit generation system may determine an operational limit (e.g., maximum gate voltage) for the circuit component based at least on a result of the age-dependent analysis of the circuit component. For example, the operational limit generation system may determine from the various comparisons from block 510 a lowest voltage that may violate a performance requirement specified by the input parameters (e.g., maximum drop in Idsat), and set such lowest voltage as the maximum gate voltage (i.e., operational limit) for the circuit component.

Although FIG. 5 discloses a particular number of operations related to method 500, method 500 may be executed with greater or fewer operations than those depicted in FIG. 5. In addition, although FIG. 5 discloses a certain order of operations to be taken with respect to method 500, the operations comprising method 500 may be completed in any suitable order.

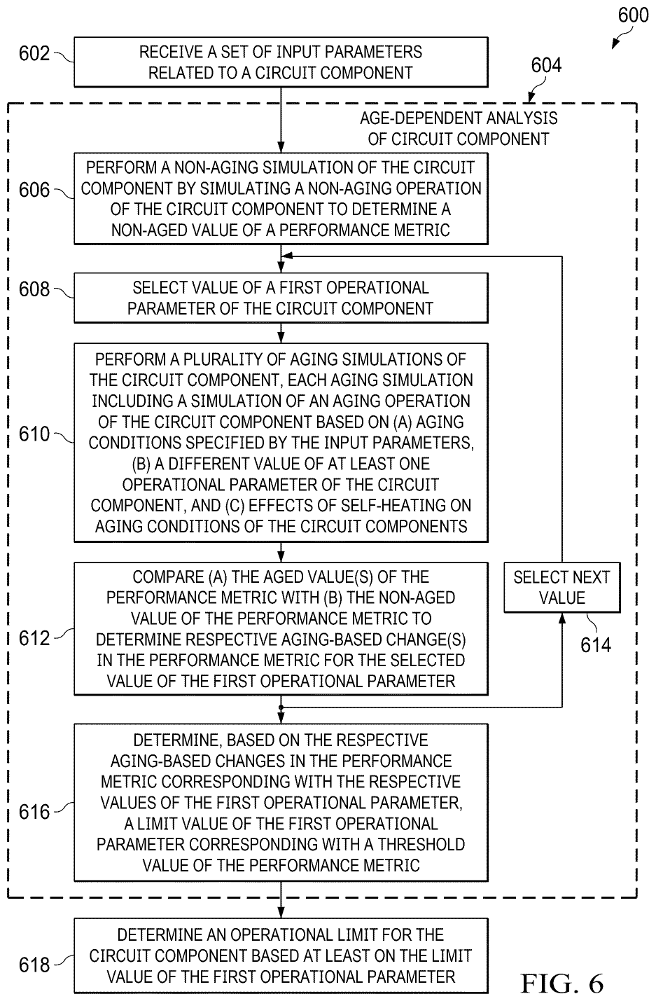

FIG. 6 illustrates a flowchart of another example method 600 for generating an operational limit (e.g., maximum operating voltage) for a circuit component (e.g., transistor). The example method 600 may be implemented by an operational limit generation system, such as operational limit generation system 104 shown in FIG. 2, for example by execution of respective logic instructions 202 (e.g., software) by processor 206.

At block 602 (similar to block 502 discussed with respect to FIG. 5), the operational limit generation system may receive a set of input parameters related to a particular circuit component, e.g., a particular transistor to be included in a circuit design for a particular application.

At block 604, the operational limit generation system may perform an age-dependent analysis of the circuit component based on the set of input parameters. The age-dependent analysis may include blocks 606-616, which may be performed in any order and may be performed at least partially simultaneously.

At block 606, the operational limit generation system may perform a non-aging simulation of the circuit component by simulating a non-aging operation of the circuit component, for example, based on one or more of the input parameters, for example using a SPICE circuit simulator program. As discussed above, simulating a non-aging operation of the circuit component may include (a) generating non-aged model of the circuit component based on respective input parameters (e.g., dimensions, materials, operating specifications, of the circuit component), and (b) operating the non-aged model according to respective input parameters (e.g., Vdd, use temperature), and without considering time-based degradation (i.e., aging) of the circuit component, to determine a resulting value of a target performance metric (e.g., a saturation current Idsat) specified by the input parameters.

At blocks 608-612, the operational limit generation system may analyze a first operational parameter of the circuit component (e.g., Vds) to generate data for determining a limit value of the first operational parameter at block 616.

At block 608, the operational limit generation system may select a first value of the first operational parameter (e.g., Vds=Vdd, wherein Vdd is specified by the input parameters).

At block 610, the operational limit generation system may perform one or more aging simulations of the circuit component using the first value of the first operational parameter (e.g., Vds=Vdd). Each aging simulation may comprise an extended simulation of an aging operation of the circuit component based on (a) aging conditions specified by the input parameters, (b) the first value of the first operational parameter (e.g., Vds=Vdd), and (c) the effects of self-heating of the circuit component, to determine a value of the target performance metric (e.g., a saturation current Idsat) resulting from such simulated operation.

In some examples, multiple aging simulations are performed using the first value of the first operational parameter (e.g., Vds=Vdd), for example using a different value of a second operational parameter (e.g., Vgs) for each respective aging simulation. Thus, each aging simulation from block 610 may use (a) aging conditions specified by the input parameters, (b) the first value of the first operational parameter (e.g., Vds=Vdd), and (c) a different value of the second operational parameter (e.g., Vgs=0, Vgs=Vdd/2, and Vgs=Vdd for three distinct aging simulations), to determine respective value of the target performance metric (e.g., Idsat) resulting from such simulated operation. Vds and Vgs values applied during an aging simulation may be referred to herein as Vds_stress and Vgs_stress, respectively.

In some examples, the operational limit generation system may use a SPICE circuit simulator program or other suitable program(s) for each aging simulation, wherein the first value of the first operational parameter (e.g., Vds=Vdd) and the respective value of the second operational parameter (e.g., Vgs=0, Vdd/2, or Vdd) for the target lifetime specified by the input parameters, which may alter certain characteristics of the circuit component (e.g., gate oxide charge, electron/hole mobility). The simulator program (e.g., a SPICE simulator) may then generate an aged model of the circuit component based on the altered characteristics of the circuit component, and operate the aged model to determine a respective value of the target performance metric (e.g., Idsat).

At block 612, the operational limit generation system may compare respective results of each aging simulation from block 610 with the results of the non-aging simulation from block 606, wherein the non-aging simulation from block 606 represents a baseline or reference. For example, the operational limit generation system may determine a change in performance (e.g., ΔIdsat) between each aging simulation and the reference non-aging simulation.

The operational limit generation system may then select a next value (e.g., a second value) for the first operational parameter (e.g., Vds =1.2*Vdd) and repeat the process of blocks 610 and 612. The operational limit generation system may continue this process for all values of the first operational parameter to be tested, for example for a range of values of Vds from Vdd to 2*Vdd.

At block 616, the operational limit generation system may determine a limit value for the first operational parameter based on the results of the analysis at blocks 608-614, for example based on the respective change in the performance metric (e.g., ΔIdsat) resulting from each iteration, i.e., the ΔIdsat resulting from each selected combination of Vds and Vgs values.

At block 616, the operational limit generation system may determine an operational limit of the circuit component (e.g., maximum gate voltage of a transistor) based at least on the limit value determined at block 616. For example, as discussed with reference to FIG. 3, the operational limit generation system may repeat the age-dependent analysis at block 604 for additional operational parameter(s) (e.g., the second operational parameter (Vgs)) and determine respective limit value(s) for such operational parameter(s), which may be compared with the limit value for the first operational parameter (Vds) to determine the operational limit of the circuit component, e.g., by selecting the lowest determined limit value.

Although FIG. 6 discloses a particular number of operations related to method 600, method 600 may be executed with greater or fewer operations than those depicted in FIG. 6. In addition, although FIG. 6 discloses a certain order of operations to be taken with respect to method 600, the operations comprising method 600 may be completed in any suitable order.

Although examples have been described above, other variations and examples may be made from this disclosure without departing from the spirit and scope of these disclosed examples.

1. A non-transitory computer-readable medium comprising instructions executable by a processor to:
receive a set of input parameters related to a circuit component;
perform an age-dependent analysis of the circuit component based on the set of input parameters, including:
performing a non-aging simulation of the circuit component by simulating a non-aging operation of the circuit component;
performing a plurality of aging simulations of the circuit component, an aging simulation of the plurality of aging simulations including a simulation of an aging operation of the circuit component based on (a) an aging condition specified by the set of input parameters, (b) a different value of at least one operational parameter of the circuit component, and (c) effects of self-heating on aging conditions of the circuit component; and
comparing respective results of the plurality of aging simulations with a result of the non-aging simulation; and
determine an operational limit for the circuit component based at least on a result of the age-dependent analysis of the circuit component.

2. The non-transitory computer-readable medium of claim 1, wherein the instructions are further executable by the processor to apply the operational limit to a circuit design to detect design violations.

3. The non-transitory computer-readable medium of claim 1, wherein the operational limit includes a safe operating area (SOA) limit for the circuit component.

4. The non-transitory computer-readable medium of claim 1, wherein the non-aging simulation and the plurality of aging simulations of the circuit component are performed by a SPICE simulator.

5. The non-transitory computer-readable medium of claim 1, wherein the aging simulation in the plurality of aging simulations of the circuit component includes a simulation of the aging operation of the circuit component based on (a) the aging condition specified by the input parameters, (b) a different parameter value combination for at least two operational parameters of the circuit component, and (c) effects of self-heating on the aging condition of the circuit component.

6. The non-transitory computer-readable medium of claim 1, wherein:
performing the plurality of aging simulations of the circuit component includes performing multiple aging simulations of the circuit component for each of multiple different values of a first operational parameter of the circuit component, wherein the multiple aging simulations for a respective value of the first operational parameter includes respective aging simulations based on (a) the aging condition specified by the input parameters, (b) the respective value of the first operational parameter, (c) multiple different values of a second operational parameter of the circuit component, and (d) effects of self-heating on aging conditions of the circuit component;
the age-dependent analysis includes:
determining, for each of at least two of the multiple different values of the first operational parameter, a respective limit value derived from results of the multiple aging simulations performed for the respective value of the first operational parameter; and
determining the operational limit for the circuit component based at least on a result of the age-dependent analysis of the circuit component includes selecting a highest or lowest value of the at least two limit values as the operational limit for the circuit component.

7. The non-transitory computer-readable medium of claim 1, wherein the circuit component is a transistor, and the at least one operational parameter of the circuit component includes at least one of a gate-source voltage (Vgs), a drain-source voltage (Vds), or a body-source voltage (Vbs).

8. The non-transitory computer-readable medium of claim 1, wherein:
the non-aging simulation of the circuit component includes simulating an effect of the non-aging operation of the circuit component on a performance metric specified in the set of input parameters; and
the aging simulation of the circuit component includes simulating an effect of the aging operation of the circuit component on the performance metric.

9. The non-transitory computer-readable medium of claim 8, wherein:
the circuit component is a transistor;
the at least one operational parameter of the circuit component includes at least one of a gate-source voltage (Vgs), a drain-source voltage (Vds), or a body-source voltage (Vbs); and
the performance metric is a saturation drain current (Idsat), a linear drain current (Idlin), or a linear threshold voltage (Vtlin).

10. The non-transitory computer-readable medium of claim 1, wherein:
performing the non-aging simulation of the circuit component includes simulating a non-aging operation of a non-aged model of the circuit component derived from the set of input parameters; and
performing a respective aging simulation of the circuit component in the plurality of aging simulations includes:
simulating an aging operation of the non-aged model of the circuit component;
generating an aged model of the circuit component based on results of the aging operation of the non-aged model of the circuit component; and
simulating an operation of the aged model of the circuit component.

11. A non-transitory computer-readable medium comprising instructions executable by a processor to:
receive a set of input parameters related to a transistor;
perform an age-dependent analysis of the transistor, including:
performing a non-aging simulation of the transistor by simulating a non-aging operation of the transistor to determine a non-aged value of a performance metric;
performing a plurality of aging simulations of the transistor, wherein performing an aging simulation in the plurality of aging simulations includes simulating an aging operation of the transistor, using (a) aging conditions specified by the input parameters, (b) a different value of at least one operational parameter of the transistor, and (c) effects of self-heating on aging conditions of the transistor, to determine a respective aged value of the performance metric corresponding with the respective value of a first operational parameter;
for each respective aging simulation, comparing (a) the respective aged value of the performance metric corresponding with the respective value of the first operational parameter with (b) the non-aged value of the performance metric to determine a respective aging-based change in the performance metric corresponding with the respective value of the first operational parameter;
determining, based on the respective aging-based changes in the performance metric corresponding with the respective values of the first operational parameter, a limit value of the first operational parameter corresponding with a threshold value of the performance metric; and
determine an operational limit for the transistor based at least on the determined limit value of the first operational parameter.

12. The non-transitory computer-readable medium of claim 11, wherein the instructions are further executable by the processor to apply the operational limit to a circuit design to detect design violations.

13. The non-transitory computer-readable medium of claim 11, wherein the operational limit is a safe operating area (SOA) limit for the transistor.

14. The non-transitory computer-readable medium of claim 11, wherein:
performing the plurality of aging simulations of the transistor includes performing multiple aging simulations of the transistor for each of the multiple different values of the first operational parameter of the transistor, wherein the multiple aging simulations for the respective value of the first operational parameter includes respective aging simulations based on (a) an aging condition specified by the input parameters, (b) the respective value of the first operational parameter, (c) multiple different values of a second operational parameter of the transistor, and (d) effects of self-heating on aging conditions of the transistor;
the age-dependent analysis includes:
determining, for each of at least two of the multiple different values of the first operational parameter, a respective limit value derived from results of the multiple aging simulations performed for the respective value of the first operational parameter; and
determining the operational limit for the transistor based at least on a result of the age-dependent analysis of the transistor includes selecting a highest or lowest value of the at least two limit values as the operational limit for the transistor.

15. The non-transitory computer-readable medium of claim 11, wherein the first operational parameter is a gate-source voltage (Vgs), a drain-source voltage (Vds), or a body-source voltage (Vbs).

16. The non-transitory computer-readable medium of claim 11, wherein:
the non-aging simulation of the transistor includes simulating an effect of the non-aging operation of the transistor on the performance metric specified in the set of input parameters; and
the aging simulation of the transistor includes simulating an effect of the aging operation of the transistor on the performance metric.

17. The non-transitory computer-readable medium of claim 16, wherein:
the first operational parameter of the transistor is a gate-source voltage (Vgs), a drain-source voltage (Vds), or a body-source voltage (Vbs); and
the performance metric is a saturation drain current (Idsat), a linear drain current (Idlin), or a linear threshold voltage (Vtlin).

18. A method, comprising:
receiving a set of input parameters related to a circuit component;
performing an age-dependent analysis of the circuit component based on the set of input parameters, including:
performing a non-aging simulation of the circuit component by simulating a non-aging operation of the circuit component;
performing a plurality of aging simulations of the circuit component, an aging simulation of the plurality of aging simulations including a simulation of an aging operation of the circuit component based on (a) aging conditions specified by the input parameters, (b) a different value of at least one operational parameter of the circuit component, and (c) effects of self-heating on aging conditions of the circuit component;
comparing respective results of the plurality of aging simulations with a result of the non-aging simulation; and
determining an operational limit for the circuit component based at least on a result of the age-dependent analysis of the circuit component.

19. The method of claim 18, wherein:
performing the plurality of aging simulations of the circuit component includes performing multiple aging simulations of the circuit component for each of multiple different values of a first operational parameter of the circuit component, wherein the multiple aging simulations for a respective value of the first operational parameter includes respective aging simulations based on (a) the aging conditions specified by the input parameters, (b) the respective value of the first operational parameter, (c) multiple different values of a second operational parameter of the circuit component, and (d) effects of self-heating on aging condition of the circuit component;
the age-dependent analysis includes:
determining, for each of at least two of the multiple different values of the first operational parameter, a respective limit value derived from results of the multiple aging simulations performed for the respective value of the first operational parameter; and
determining the operational limit for the circuit component based at least on a result of the age-dependent analysis of the circuit component includes selecting a highest or lowest value of the at least two limit values as the operational limit for the circuit component.

20. A system, comprising:
an electronic design automation (EDA) tool for development of circuit design including a circuit component;
an operational limit generation system integrated in the EDA tool, the operational limit generation system including instructions stored in non-transitory computer-readable medium and executable by a processor to:
receive a set of input parameters related to a circuit component;
perform an age-dependent analysis of the circuit component based on the set of input parameters, including:
performing a non-aging simulation of the circuit component by simulating a non-aging operation of the circuit component;
performing a plurality of aging simulations of the circuit component, an aging simulation of the plurality of aging simulations including a simulation of an aging operation of the circuit component based on (a) aging conditions specified by the input parameters, (b) a different value of at least one operational parameter of the circuit component, and (c) effects of self-heating on aging conditions of the circuit component;
comparing respective results of the plurality of aging simulations with a result of the non-aging simulation; and
determine an operational limit for the circuit component based at least on a result of the age-dependent analysis of the circuit component.
